(19) United States
(12) Patent Application Publication
(10) Pub. No.: US 2003/0039814 A1
(43) Pub. Date: Feb. 27, 2003

(54) Biaxially oriented, metallized multilayer films including non-migratory slip agent

(76) Inventors: Michael John Bader, Fairport, NY (US); Richard A. Rehkugler, Fairport, NY (US)

Correspondence Address: ExxonMobil Chemical Company, P.O. Box 2149, Baytown, TX, 77522, US

(21) Appl. No.: 09/896,990

(22) Filed: Jul. 2, 2001

(51) Int. Cl. B32B 15/08; B32B 1/08; B32B 7/02; B32B 27/08

(52) U.S. Cl. 428/213; 428/216; 428/327; 428/910; 428/35.3; 428/35.8; 428/35.9; 428/516; 428/461; 428/463

(57) ABSTRACT

Multilayer, generally three layer films, with non-migratory slip agents in a skin or outer layer of the multilayer films are contemplated. The films may be metallized. The particle size of the non-migratory slip will generally be equal to or larger than the thickness of the skin layer of which they are a part. The films will generally be oriented, usually biaxially oriented.

### TECHNICAL FIELD

This invention relates generally to multilayer films containing materials that deliver acceptable coefficient of friction (COF) without substantially diminishing the ability of a film to be metallized, while providing a hermetic seal. More specifically this multilayer film has a non-migratory slip agent in one outer-most layer.

### BACKGROUND

In the packaging of certain types of foods, such as snack foods, including candies, potato chips, cookies and the like, it is common practice to employ a multi-layer film. Polypropylene films are widely used in the packaging industry due to their superior physical properties, such as transparency, stiffness, moisture barrier characteristics and others. Despite these highly desirable properties, unmodified polypropylene film has the property of having a high inherent coefficient of friction and film-to-film destructive blocking on storage. This high film-to-film coefficient of friction makes polypropylene films difficult to employ in automatic packaging equipment in their unmodified form.

Coefficient of friction characteristics of polypropylene and other thermoplastic films may be modified by the inclusion of slip agents in the polymer. Most of these slip agents are migratory, such as polydialkyl siloxane or fatty amides, such as, erucamide and oleamide. Although they do reduce the coefficient of friction, their effectiveness depends upon the ability to migrate to the surface of the film. The development of the desired low coefficient of friction value is dependent upon the type and amounts of amides, and time and temperature aging effects. Even the heat history of the film, while in storage and shipping and during subsequent converter processes, effects the coefficient of friction. In addition, the presence of these types of fatty acid amides on the film surface results in adverse appearance effects manifested by an increase in haze, a decrease in gloss and the presence of streaks. These materials also adversely effect the wettability and adhesion of solvent and water-based inks, coatings and adhesives, as well as potentially negatively effecting adhesion of metal and/or coatings.

In PCT US94/14280 a film structure containing a non-migratory particulate crosslinked hydrocarbyl-substituted polysiloxane slip agent is described. The film structure includes at least one layer of an olefin homo-, co- or terpolymer having a surface-treated external surface which is printable, sealable and machinable and as combined slip agent and antiblock a non-migratory particulate crosslinked hydrocarbyl-substituted polysiloxane, and/or liquid polydimethyl siloxane.

Additional descriptions of olefinic polymer films in which particulate siloxane resins are employed to provide improved films will be found in U.S. Pat. Nos. 4,966,933; 4,769,418; 4,652,618; and 4,594,134.

U.S. Pat. No. 4,966,933 suggests a propylene polymer film containing a propylene polymer, a fine powder of a crosslinked silicone resin and a hydroxy-fatty acid glyceride. The provided amounts of fine powder of silicone resin and hydroxy-fatty acid glyceride in the metallization layer are required for adaptability to vacuum deposition. Example 3 provides a two-layer coextruded film in which the fine powder of crosslinked silicone resin is compounded with polypropylene homopolymer to form a metallization layer (B) and the fine powder of crosslinked silicone resin is compounded with an ethylene/propylene/butene-1 copolymer to form a skin layer (a). The ratio of reported particle size to skin thickness is about 0.143 for skin layer (B) and about 1.29 for skin layer (A).

### SUMMARY

We have discovered that non-migratory polymethylacrylate slip agents, when included into a seal layer of a three layer multilayer film, provide a film with acceptable COF, without substantially diminishing the ability of the films to be metallized.

More specifically, embodiments of our invention provide a film structure which includes an olefinic polymer core layer having at least one sealant skin layer comprising an olefin polymer, having an external surface which is sealable, the sealant skin layer containing a non-migratory particulate.

On the other surface of the olefin polymer core layer there is a metallizable layer having an external surface, which is substantially free of the non-migratory particulate, polymethylmethacrylate (PMMA). The non-migratory slip agent does not, generally, effect film barrier properties or lamination bond strengths to other oriented polypropylene based films or polyester based films that might be laminated thereto.

In other embodiments the invention relates to a film structure comprising a first sealant skin layer (a) of an olefin co- or ter-polymer on one side of a core layer (b), the first sealant skin layer containing a non-migratory particulate. On an opposite side of the core layer there is a second skin layer (c), which may include an ethylene homopolymer, which is substantially free of the particulate PMMA of the first skin layer. In further embodiments of our invention, the film structure is a three layer film.

Embodiments of our invention further relate to a method of making a film comprising the step of coextruding a film structure, the film structure comprising a heat sealable layer (a) comprising an olefinic co- or terpolymer containing a particulate PMMA; a core layer (b) comprising an olefinic polymer and an outer layer (c) comprising an ethylene homopolymer which is substantially free of the particulate PMMA of layer (a).

These and other aspects, features and advantages of embodiments of the present invention will become better understood with reference to the following description and appended claims.

### DETAILED DESCRIPTION

In certain embodiments of our invention, non-migratory slip agent containing multilayer films are contemplated. The non-migratory slip agent will generally be in a seal layer. These multilayer films will exhibit an acceptable COF as well as excellent metallizability characteristics, as compared to multilayer films containing migratory slip.

The combination of acceptable COF and excellent metallizability, along with excellent sealability, will be especially useful in packaging films, more particularly snack packaging, although other uses are contemplated.

Following is a detailed description of certain preferred combinations of non-migratory slip containing multilayer films, their fabrication into useful articles, and use of these articles. Those skilled in the art will appreciate that numerous modifications to these preferred embodiments may be made without departing from the scope of our invention. For example, while certain specific non-migratory slip containing films are exemplified, other non-migratory slip containing films are also contemplated.

To the extent that this description is specific, it is solely for the purpose of illustrating certain preferred embodiments of the invention and should not be taken as limiting the present inventive concepts to these specific embodiments.

More specifically, embodiments of our invention provides a film structure which includes a core layer having at least one sealant skin layer contiguous to a surface of the core layer, the sealant skin layer comprising an olefin polymer having an external surface which is sealable and machinable, the sealant skin layer containing a particulate non-migratory slip system which provides improved antiblock and/or slip properties. The particulate non-migratory slip system includes non-migratory PMMA particles.

On the other side of the core layer there may be metallizable layer having an external surface, which is substantially free of the non-migratory slip agent. By substantially free, we intend <5, or <2, or <1, or <0.5, or 0 weight percent of the non-migratory slip, based on the weight of the metallizable layer. The non-migratory slip agent does not generally effect film barrier properties or lamination bond strengths to other oriented polypropylene based films or polyester based films. In one embodiment of the invention, this non-migratory slip agent containing film layer may be metallized on its outermost surface. We have found that the non-migratory slip agent included in the sealant layer may reduce scratching of the metal surface when the film is wound into a roll.

Embodiments of the invention relate to a film structure including a first sealant skin layer (a) of an olefin co- or ter-polymer having an external surface which is sealable on one side of a core layer (b), the first skin layer containing an non-migratory slip agent, including a non-migratory PMMA, on an opposite side of the core layer there is a second skin layer (c) which includes an ethylene homopolymer which is substantially free of the non-migratory slip agent of the first sealant skin layer, the second skin layer, optionally, having a metal deposited thereon.

Embodiments of the invention further relate to a method of making a film comprising the steps of coextruding a film structure, the film structure comprising a heat sealable layer (a) comprising an olefinic co- or terpolymer containing an non-migratory slip agent, including PMMA particles; a core layer (b) including an olefinic polymer and a layer (c) further including an ethylene homopolymer which is substantially free of the non-migratory slip agent of layer (a); and, optionally, metallizing the surface of the layer (c) by depositing a metal thereon.

Core Layer

The core layer of the multilayer films of embodiments of our invention may include isotactic polypropylene. The core layer will have a first and a second surface.

Isotactic polypropylene (iPP) contemplated in embodiments of our invention include those iPPs made using either Ziegler-Natta or metallocene catalysts or combinations thereof. While generally contemplating homo isotactic polypropylene, random and impact copolymer polypropylenes are also contemplated with an ethylene, a-olefin, diolefin or combinations thereof, content up to 10% (wt.).

MFRs of the iPP may range from 0.1 to 1000, or 1 to 500, or 10 to 250, or 10 to 100 dg/min.

The core layer of embodiments of our invention will have a thickness in the total film in the range of from 3-20 μm, or 5-18 μm, or 5-15 μm. Generally the core layer will be present in the total film in the range of from 20-60 weight percent, or in the range of from 30-50 weight percent, based on the total weight of the film.

Moreover, although skin layers are referred to, the skin layers may have additional structures bonded thereto, based on the functional requirements of the overall structure. Such materials bonded thereto will generally further enhance the present three layer structure for specific uses.

When an opaque label or film structure is desired, the core layer of the film structure of the present invention may be formed in accordance with U.S. Pat. No. 4,377,616.

Where opacifying agents are desired, they may be incorporated in the core layer, in a proportion of up to 10%, or up to 5%, or up to 1%, by weight, based on the total weight of the core layer. Suitable conventional opacifying agents can be added to the melt mixture of the core layer before extrusion. Opacifying compounds are generally well known. They may be exemplified by iron oxides, carbon black, aluminum, aluminum oxide, titanium dioxide, and talc.

The core layer may be an oriented polypropylene film. The orientation may be uniaxial, or biaxial. Further, in other embodiments, the film structure may be oriented subsequent to application of any layer, or may be oriented after the structure is complete.

The total film will have a thickness in the range of from 10-40 or 15-35 μm.

First Skin Layer

A first sealant skin layer will be contiguous to a first surface of the core layer in embodiments of our invention. The polymer materials, which are contemplated for use in forming this first sealant skin layer, are suitably exemplified by heat sealable polyolefinic copolymers and terpolymers and blends thereof. The copolymers are exemplified by and include, but are not limited to, block copolymers, for example of ethylene and propylene, random copolymers. The terpolymers are exemplified by ethylene-propylene-butene-1 terpolymers. Also, heat sealable blends can be utilized in providing layer (a). Thus, along with the copolymer or terpolymer, there can be polypropylene homopolymer, e.g. one which is the same as, or different from, the isotactic polypropylene of the core layer (b) or other material which does not impair the heat sealability of this layer. The first skin layer may additionally or alternatively include, but is not limited to, materials selected from one or more of ethylene propylene random copolymers (EP rcp), propylene butene copolymer (PB), low density polyethylene (LDPE), linear low density polyethylene (LLDPE), medium density polyethylene (MDPE), or combinations thereof.

The first skin layer has a thickness in the range of from 3-25 μm, or 3-20 μm, or expressed alternatively, the first sealant skin layer will be present in the total film in the range of from 10-70, or 10-60, or 15-60 weight percent, based on the total weight of the film.

The first skin sealant layer also includes a non-migratory slip agent, polymethyl methacrylate (PMMA).

The non-migratory slip agent will have a (mean) particle size in the range of from 5-25 μm, or 7-20 μm, or 10-18 μm. Alternatively the particle size of the non-migratory slip agent may be >5%, or >10%, or >15%, or >20%, or >40%, or >50%, or >60%, or >70%, or >100% greater in diameter than the thickness of the second skin layer.

Suitable ethylene-propylene-butene-1 (EPB) terpolymers are those obtained from the random inter-polymerization of from 1-8 weight percent ethylene, or from 3-7 weight percent ethylene with from 1-10 weight percent butene-1, or from 2-8 weight percent butene-1 with propylene representing the balance. The foregoing EPB terpolymers may have a melt index at 230° C. of from 2-16, or from 3-7 dg/min, a crystalline melting point of from 100° C.-140° C., an average molecular weight of from 25,000-100,000 and a density within the range of from 0.89-0.92 gm/cm³.

Generally, there will be no separate layer between the core layer and the first skin sealant layer, although such layer is not prohibited.

Second Skin Layer

The second skin layer of embodiments of our invention will generally be contiguous to a second surface of the core layer. Contemplated for use in forming the second skin layer may be metallizable polymeric materials. Typical examples of such materials are those selected from one of, ethylene polymers such as linear low density polyethylene (LLDPE), low density polyethylene (LDPE), medium density polyethylene (MDPE), high density polyethylene (HDPE) or blends thereof. Other contemplated metallizable resins include ethylene-vinyl alcohol copolymer (EVOH), ethylene-vinyl acetate copolymer (EVA) and polypropylene homopolymer. The second skin layer may have a thickness in the range of from 1.5-12 μm, or 2.5-10 μm. or the second skin layer may be present in the total film in the range of from 10-40 or 12-35 weight percent, based on the total weight of the film.

This second skin layer may be formed without adding the non-migratory slip, which is included in the first skin layer. Thus, the second skin layer is considered to be substantially free of the non-migratory slip used in first skin layer. This does not however, exclude the incidental presence of components of the non-migratory slip which might occur upon subsequent handling of the finished film, for example upon winding the film onto a roll, whereby non-migratory particles from the first skin layer might be sloughed onto the external surface of or imbedded into the second skin layer.

The second skin layer may be metallized. Prior to metallization, the second skin layer may be treated with one of flame, polarized flame, or corona.

Non-Migratory Slip

Migratory slip agents, such as polydialkyl siloxane, fatty amides, and the like, are not considered part of embodiments of our invention, as by their nature they can migrate to the surface of a layer to be metallized and either make depositing metal difficult or lead to partial delamination of the metal from the film surface. In embodiments of our invention, the non-migratory slip agent will be present in the second skin layer in the range of from 500-10,000 ppm, or 1000-8000 ppm, or 1200-6000 ppm, or 1500-4000 ppm, based on the total weight of the layer containing the non-migratory slip.

Prior to extrusion, in accordance with embodiments of the present invention, the first seal layer may be compounded with an effective amount of a non-migratory slip.

Particulate, generally spherical materials, including PMMA resins such as EPOSTAR®, manufactured by Nippon Shokubai Co., Ltd., are contemplated. Other commercial sources of similar suitable materials are also known to exist. By non-migratory, we intend that these particulates do not generally change location throughout the layers of the film in the manner of the migratory slip agents.

Heat Seals/Seal Strength

Heat seals in packaging can generally be lap, fin or crimp. Most frequently, vertical form fill and seal and/or horizontal form fill and seal (VFFS and/or HFFS, respectively) useful in snack packaging will employ a fin seal and two crimp seals. For extended shelf life, a hermetic is desirable, one that does not permit the passage of gas.

Metallization

In another embodiment, the exposed surface of the second skin layer may be metallized. This occurs by application of a thin layer of metal. Metal deposition techniques are well known in the art. Typically, the metal layer is applied to an optical density of 1.5-5.0, or 1.8-2.6. Optical density provides a determination of the absorption of visual light and is determined by standard techniques. To obtain the optical density values of the instant films a commercial densitometer was used such a Macbeth model TD 932, Tobias Densitometer model TDX or Macbeth model TD903. The densitometer is set to zero with no film specimen. A film specimen is placed over the aperture plate of the densitometer with the test surface facing upwards. The probe arm is pressed down and the resulting optical density value is recorded.

Usually vacuum deposition is the method of choice for metallizing the film. While aluminum is a contemplated metal, other metals, e.g. zinc, gold, silver, etc. which are capable of being deposited to the surface of the film can also be employed.

Typically, prior to metallization, the surface of the second skin layer may be treated to improve metal adhesion by corona, plasma, flame, or polarized flame.

The resulting metallized film has low water vapor transmission rate characteristics and low oxygen transmission rate characteristics. These improved physical properties make the film ideally suited for packaging food products, even those comprising liquids.

Orientation

Embodiments of our invention include possible orientation of the multilayer films. Orientation in the direction of extrusion is known as machine direction orientation (MD), orientation perpendicular to direction of extrusion is known as transverse direction (TD). Orientation may be accomplished by stretching or pulling a blown film in the MD, using the blow-up ratio to accomplish TD orientation, or both may be used. Blown films or cast films may also be oriented by a tenter frame orientation subsequent to the film formation process, again in one or both directions. Orientation ratios may generally be in the range of 1:1-1:15 or MD 1:4-1:10 or in TD 1:7-1:12. Orientation may occur after any layer is added. Orientation may be limited to use of a biaxially oriented polypropylene film as the core layer.

Other Ingredients

Other ingredients in our inventive blends include, but are not limited to, pigments, colorants, antioxidants, antiozonants, antifogs, antistats, fillers such as calcium carbonate, diatomaceous earth, carbon black, combinations thereof, and the like.

Either or both skin layers can also contain pigments, fillers, stabilizers, light protective agents or other suitable modifying ingredients if desired. Further, either or both skin layers can optionally contain a minor amount of an antiblock material, such as, clays, talc, glass, and the like. These antiblock materials can be used alone, or different sizes and shapes can be blended to optimize machinability.

The core layer can contain anti-static agents, e.g., cocoamine or N,N bis(2-hydroxyethyl) sterylamine. Suitable amines include mono-, di, or tertiary amines.

Definitions and Testing Protocols

| | |
|---|---|
| Melt Flow Rate (MFR): | ASTM D 1238, condition L |
| Melt Index (MI): | ASTM D 1238, condition E |

Experimental

Materials:

Chisso 7701 available from Chisso Corporation

Fina 3371 available from Fina Oil and Chemical Co.

ExxonMobil HD6704.67 available from ExxonMobil Chemical Co., Houston, Tex.

### EXAMPLE 1

The coextruded biaxially oriented film structure is a polypropylene core (Fina 3371), with a 26 gauge (6.5 micron) sealant or second skin layer of Chisso 7701. The total film gauge is 90 gauge (23 micron). This sealant layer contains approximately 2,000 ppm of a non-migratory slip agent, and the first skin layer being a metallizable HDPE (ExxonMobil HD6704.67) layer. The average particle size of the Epostar® MA 1010 spheres is 10 μm. This film structure is also flame treated on the HDPE side to improve adhesion of the aluminum to the film and to optimize the lamination bond strengths.

The resultant biaxially oriented film structures have the following properties tested immediately off the orienter. The orientation is 4.5 MD and 9 TD.

COF (U/U)

| Additive Loading | MST (U/U) | Static | Kinetic | % Haze | OTR |
|---|---|---|---|---|---|
| 2000 ppm | 217 F. | 0.88 | 0.83 | 6.20 | 2.00 |

Where U/U is untreated to untreated.

This film, metallizes well with substantially no blocking or winding problems through orientation, slitting and metallization. The hermetic seal range is fairly narrow on a Fuji Model FW-770 Packaging equipment at 50 PPM (packages per minute). The hermetic crimp seal range is 40° F., and the hermetic fin seal range is 10° F. The crimp seal strength is 1300-1550 gm/in in this hermetic seal region, and the fin seal strength is 1900-2400 gm/in.

### EXAMPLE 2

The second film structure is identical to the first example, except the seal or second skin layer thickness is increased from 26 gauge (6.5 micron) to 40 gauge (10 micron).

The resultant biaxially oriented film structures have the following properties tested immediately off the orienter:

COF (U/U)

| Additive Loading | MST (U/U) | Static | Kinetic | % Haze | OTR |
|---|---|---|---|---|---|
| 2000 ppm | 219 F. | 0.90 | 0.84 | 6.60 | 2.35 |

This film, metallizes well with substantially no blocking or winding problems through orientation, slitting and metallization. The hermetic seal range is significantly greater than the product design in Example 1 on the Fuji 7700 Packaging equipment at 50 PPM. The hermetic crimp seal range is 50 F., and the hermetic fin seal range is 30 F. The crimp seal strength is 2300-3000 gm/in in this hermetic seal region, and the fin seal strength is 3000 gm/in or greater.

Although the present invention has been described in considerable detail with reference to certain preferred embodiments thereof, other embodiments are possible. For example, while multilayer films containing non-migratory slip are exemplified at certain loadings and sizes, other loadings and sizes are contemplated. Therefore, the spirit and scope of the appended claims should not be limited to the description of the preferred embodiments contained herein.

We claim:

1. A package including a three layer film, said film comprising:
a) a seal layer, said seal layer being an ethylene, propylene, butene terpolymer, said seal layer making up in the range of from 15-60 weight % of said film, based on the total weight of said film, said seal layer having a thickness in the range of from 5.5-10 μm, said seal layer including:
a particulate poly methyl methacrylate (PMMA), present in said seal layer in the range of from 500-10,000 ppm, based on the total weight of the seal layer, said particulate PMMA having a mean particle size in the range of from 10-20 μm, with the proviso that the particulate PMMA size is >20% of the thickness of the seal layer;
b) a core layer, said core layer being an isotactic polypropylene (iPP), said core layer present in said film in the range of from 30-50 weight %, based on the total weight of said film, said core layer having a first and a second surface, said seal layer being contiguous to said first surface of said core layer; and
c) a metallizable layer, contiguous to the second surface of said core layer, said metallizable layer being a high density polyethylene (HDPE), said metallizable layer making up in the range of from 15-35 weight percent of the total film, said metallizable layer being present in said film in the range of from 1.5-12 μm.

2. The package of claim 1, wherein said film is biaxially oriented.

3. The package of claim 2, wherein said metallizable layer is treated with one of corona, flame or polarized flame and metallized.

4. The package of claim 3, wherein said seal layer is present in said film at a thickness in the range of from 3-20 μm, said PMMA is present in said seal layer in the range of from 1200-8000 ppm, said core layer has a thickness of 5-18 μm, said metallizable layer has a thickness in the range of from 2.5-10 μm, and the particulate PMMA size is >40% of the thickness of the seal layer.

5. The package of claim 5, wherein said seal layer is present at a thickness in the range of from 5-10 μm, said PMMA is present in said seal layer in the range of from 1500-6000 ppm, said core layer has a thickness in the range of from 5-15 μm, wherein said particulate PMMA size is >50% of the thickness of the seal layer.

6. A snack package, said package including a biaxially oriented metallized multi-layer film, said film comprising:
a) a core layer having a first and a second surface, said core layer having a first and a second surface, said core layer having a thickness in the range of from 5-15 μm, said core layer being iPP;
b) a seal layer contiguous to said first surface of said core layer, said seal layer having a thickness in the range of from 3-20 μm, said seal layer including a particulate PMMA, present in said seal layer in the range of from 1500-4000 ppm, based on the total weight of the seal layer, said PMMA size being >50% of the thickness of the seal layer; and
c) a metallizable layer, said metallizable layer being HDPE, having a thickness in the range of from 2.5-10 μm, said metallizable layer being contiguous to said second surface of said core layer,
wherein said c) is treated on its outermost surface by one of corona, flame, or polarized flame, and then metallized.

7. A biaxially oriented, multilayer film, comprising:
a) a polypropylene core layer, said core layer having a thickness in the range of from 3-20 μm, said core layer having a first and a second surface;
b) a first skin layer contiguous to said first surface of said core layer, said first skin layer including a material selected from one of ethylene propylene butene terpolymer, ethylene propylene random copolymers (EP rcp), propylene butene copolymer (PB), low density polyethylene (LDPE), linear low density polyethylene (LLDPE), medium density polyethylene (MDPE), or combinations thereof ethylene propylene butene terpolymer and polymethyl methacrylate, (PMMA) said first skin layer having a thickness in the range of from 3-25 μm, and where in said PMMA has a mean particle size diameter at least 10% greater than the thickness of said first skin layer; and
c) a second skin layer contiguous to said second surface of said core layer, said second skin layer including a material selected from one of high density polyethylene (HDPE), medium density polyethylene (MDPE), and combinations thereof, wherein said second skin layer has thickness in the range of from 1.5-12 μm.

8. The biaxially oriented, multilayer film of claim 7, wherein said film, on an outermost surface of said first skin layer is treated by one of corona, flame or polarized flame, and where in said PMMA has a mean particle size diameter at least 15% greater than the thickness of said first skin layer.

9. The biaxially oriented, multilayer film of claim 8 where in said first skin layer is metallized, and where in said PMMA has a mean particle size diameter at least 20% greater than the thickness of said first skin layer.

10. The biaxially oriented, multilayer film of claim 9, wherein said PMMA size is >40% of the thickness of the first skin layer.

11. The biaxially oriented, multilayer film of claim 10, wherein said sealant layer has a thickness in the range of from 3-20 μm, and where in said PMMA has a mean particle size diameter at least 50% greater than the thickness of said first skin layer.

12. The biaxially oriented, multilayer film of claim 11, wherein said PMMA is present in said seal layer in the range of from 1000-8000 ppm, based on the total weight of said second layer.

13. The biaxially oriented, multilayer film of claim 12, wherein said PMMA is present in said seal layer in the range of from 1200-6000 ppm, based on the total weight of said film.

14. The biaxially oriented, multilayer film of claim 13, wherein said second skin layer is HDPE.
